(19) United States
(12) Patent Application Publication
(10) Pub. No.: US 2014/0230996 A1
(43) Pub. Date: Aug. 21, 2014

(54) HEAT SHRINKABLE TUBE MOUNT METHOD AND HEAT SHRINKABLE TUBE MOUNTING JIG

(71) Applicant: YAZAKI CORPORATION, Tokyo (JP)

(72) Inventor: Takahiro SAITO, Kosai-shi (JP)

(73) Assignee: YAZAKI CORPORATION, Tokyo (JP)

(21) Appl. No.: 14/263,485

(22) Filed: Apr. 28, 2014

Related U.S. Application Data
(63) Continuation of application No. PCT/JP2012/081578, filed on Nov. 29, 2012.

(30) Foreign Application Priority Data
Nov. 29, 2011 (JP) 2011-260810

(51) Int. Cl. H01R 43/00; H01R 13/52

(52) U.S. Cl. CPC H01R 43/005; H01R 13/5216
USPC 156/86; 29/728

(57) ABSTRACT

A heat shrinkable tube mount method includes fitting a terminal of a terminal-equipped electric wire to a terminal fit recess of a lower frame provided on a base, sheathing a core wire crimp section of the terminal led out of the lower frame with a heat shrinkable tube containing therein an adhesive and bringing a one tube end into contact with a dam wall of the lower frame, restricting movement of the terminal, by covering the terminal fit recess with an upper frame that is joined to the lower frame in a turnable manner, pinching a portion of a peripheral wall of the heat shrinkable tube between a tube fixing claw on the upper frame and the terminal at an instant when the upper frame covers the terminal fit recess, and turning a clamp lever to a pinching position.

### CROSS REFERENCE TO RELATED APPLICATIONS

This application is a continuation of PCT application No. PCT/JP2012/081578, which was filed on Nov. 29, 2012 based on Japanese Patent Application (No. 2011-260810) filed on Nov. 29, 2011, the contents of which are incorporated herein by reference.

### BACKGROUND OF THE INVENTION

1. Field of the Invention

The invention relates to a heat shrinkable tube mount method and a heat shrinkable tube mounting jig for mounting a heat shrinkable tube to a terminal-equipped electric wire whose core wire is crimped to a core wire crimp section of a terminal.

2. Description of the Related Art

When; for instance, an earth terminal crimped to an electric wire, is connected to an auto body that is an area to be exposed to water, water sometimes penetrates into the electric wire from a bare portion of the core wire crimped to the earth terminal, thereby entering a device or equipment connected to the other end of the electric wire. In order to prevent occurrence of water ingress via such a route, a swaged portion of the terminal is often subjected to waterproof treatment (see; for instance, PTL 1).

Incidentally, for instance, a jig 503 attached to a jig grip 501 shown in FIG. 10 is used for waterproofing such a swaged portion of the terminal. The jig 503 is formed by punching and bending a sheet of metal plate and has an upper grip 505 and a lower grip 507. One end of the upper grip 505 and one end of the lower grip are free ends. A tube press 509, which has an about 90-degree bend toward the upper grip 505 and another subsequent bend toward an extremity of the jig and thereby assumes a substantially L-shaped side geometry, is provided at an extremity of the lower grip 507. The jig 503 is fitted to a combination LA terminal 517 in which front and back areas of a core wire crimp section 523 are covered with a heat shrinkable tube 521, such that an adhesive flow stopper 511 is positioned between extremities of a plurality of bundled core wires 515 of an electric wire 513 and an electrical contact 519 of the combination LA terminal 517.

In the jig 503, an end of the heat shrinkable tube 521 that covers the extremities of the core wires 515 is pressed by the tube press 509, thereby preventing occurrence of milk-off (a phenomenon in which a molten adhesive works as a lubricant, to thus move the heat shrinkable tube 521) or shrink-back (a phenomenon in which a length of the heat shrinkable tube 521 contracts). As a result, the molten adhesive reaches the adhesive flow stopper 511 without fail.

### CITATION LIST

### Patent Literature

[PTL 1] Japanese Patent Publication No. JP-A-2005-135858

### SUMMARY OF THE INVENTION

However, in the existing jig 503, a periphery of the cylindrical heat shrinkable tube 521 is pressed by the small-plate-like tube press 509 having an L-shaped bend. Therefore, anchorage strength of the heat shrinkable tube 521 cannot be increased, and the heat shrinkable tube 521 might be thrust back by the adhesive that has been extruded during shrinkage and collided against the adhesive flow stopper 511 to thereby come off the tube press 509. If the heat shrinkable tube 521 comes off the press, the adhesive might effuse to an unwanted area to thereby deteriorate reliability of a water stop structure. Since clearance 525 is formed between the heat shrinkable tube 521 and the adhesive flow stopper 511, a problem of an increase in amount of adhesive outflow arises.

The invention has been conceived in light of the circumstance and aims at providing a heat shrinkable tube mount method, a heat shrinkable tube mounting jig, and a terminal-equipped electric wire that make it possible to reliably fix a heat shrinkable tube without involvement of an adhesive leakage and fill the heat shrinkable tube, which is located in close proximity to an electrical contact, up to its open end with an adhesive.

In order to achieve the object described above, a heat shrinkable tube mount method and a heat shrinkable tube mounting jig according to the invention is characterized by the following (1) to (7).

(1) A heat shrinkable tube mount method comprising:

a step of fitting a terminal of a terminal-equipped electric wire to a terminal fit recess of a lower frame provided on a base;

a step of sheathing a core wire crimp section of the terminal led out of the lower frame with a heat shrinkable tube containing therein an adhesive and bringing a one tube end into contact with a dam wall of the lower frame;

a step of restricting movement of the terminal in a direction orthogonal to one plane of the terminal, by covering the terminal fit recess with an upper frame that is joined to the lower frame in a turnable manner;

a step of pinching a portion of a peripheral wall of the heat shrinkable tube between a tube fixing claw projectingly provided on the upper frame and the terminal at an instant when the upper frame covers the terminal fit recess; and

a step of turning a clamp lever, which is provided on the base in a turnable manner, to a pinching position, where the clamp lever pinches the lower frame and the upper frame.

According to the heat shrinkable tube mount method having the configuration described in connection with (1), the heat shrinkable tube into which the core wire crimp section of the terminal fitted to the terminal fit recess of the lower frame is brought into contact with the one tube end of the dam wall of the lower frame. A space that is to be filled with an adhesive and that is closed by the dam wall is formed at an opening of the one tube end. The upper frame is turned in this state, whereupon the terminal is fixedly pinched between the lower frame and the upper frame. The tube fixing claw provided on the upper frame is pressed against the portion of the peripheral wall of the one tube end at an instant when the terminal is fixed. Thus, the portion of the peripheral wall is pinched between the terminal and the tube fixing claw. The one tube end is fixed in close proximity to the dam wall without clearance from which an adhesive might run out.

(2) A heat shrinkable tube mounting jig comprising:

a lower frame that is provided on a base and that has a terminal fit recess for restricting in-plane movement of a terminal of a terminal-equipped electric wire;

a dam wall that is formed on the lower frame and with which a one tube end of a heat shrinkable tube, in which a core wire crimp section of the terminal is sheathed, is brought into contact;

an upper frame that is joined to the lower frame in a turnable manner and covers the terminal fit recess, to thus restrict movement of the terminal in a direction perpendicular to the one plane of the terminal;

a tube fixing claw that is provided projectingly on the upper frame and that pinches a portion of a peripheral wall of the heat shrinkable tube along with the terminal; and

a clamp lever that is provided on the base in a turnable manner and that is turned to a pinching position, to thus pinch the lower frame and the upper frame.

In the heat shrinkable tube mounting jig having the configuration described in connection with (2), the terminal is positioned in the terminal fit recess of the lower frame. When the core wire crimp section of the terminal positioned in the terminal fit recess is sheathed in the heat shrinkable tube, the one tube end of the heat shrinkable tube is brought into contact with the dam wall. At an instant when the upper frame is turned and when the terminal is fixedly pinched between the lower frame and the upper frame, the tube fixing claw provided projectingly on the upper frame is pressed against the portion of the peripheral wall of the one tube end. The tube fixing claw pinches the portion of the peripheral wall of the one tube end between the lower frame and the upper frame. Accordingly, the one tube end can be pinched without fail. Further, the opening of the one tube end is closed by the dam wall, and a portion of the peripheral wall is fixed to the base by means of the terminal and the tube fixing claw. This eliminates clearance between the dam wall and the one tube end from which an adhesive might run out. Thus, the one tube end can be positioned in close proximity to the electrical contact of the terminal.

(3) The heat shrinkable tube mounting jig according to the above (2), wherein the tube fixing claw as a plurality of parallel press teeth that extend in a direction orthogonal to an axial direction of the heat shrinkable tube.

In the heat shrinkable tube mounting jig having the configuration described in connection with (3), the tube fixing claw that presses the one portion of the peripheral wall of the heat shrinkable tube assumes a shape of pressing teeth. Hence, the tube fixing claw can pinch the portion of the peripheral wall by dint of contact pressure that is greater than that generated by a planar fixing claw. Hence, disengagement of the heat shrinkable tube becomes more difficult.

(4) The heat shrinkable tube mounting jig according to the above (2) or (3), wherein the base has a temporary retention claw that is engaged with an edge of the terminal positioned in the terminal fit recess, thereby restricting uplift of the terminal from the terminal fitting recess.

In the heat shrinkable tube mounting jig having the configuration described in connection with (4), the terminal can be temporarily retained in the terminal fit recess before the turned upper frame covers the terminal fit recess. Work for sheathing a core crimp section that must be performed before turning of the upper frame is facilitated.

(5) The heat shrinkable tube mounting jig according to any one of above (2) to (4), wherein the base is provided with a plate for ensuring clearance to be filled that is inserted between a plurality of electric wires connected to the terminal.

In the heat shrinkable tube mounting jig having the configuration described in connection with (5), when the electric wire connected to the terminal is plural, the plate for ensuring clearance to be filled is inserted between the electric wires, thereby preventing twisting of the plurality of electric wires, and the plurality of electric wires can be laid in parallel. Thereby, clearance between the electric wires can be t filled with an adhesive, thereby preventing occurrence of a space not to be filled with an adhesive between the electric wires.

(6) The heat shrinkable tube mounting jig according to any one of the above (2) to (5), wherein the terminal fitting recess fits to the terminal in a direction in which the core wire crimp section faces down, and the tube fixing claw pinches the portion of the peripheral wall along with a terminal back face, which is an opposite side, of the core wire crimp section.

In the heat shrinkable tube mounting jig having the configuration described in connection with (6), the terminal back face of the terminal fitted to the terminal fit recess faces up, and the core wire crimp section faces down. In the heat shrinkable tube into which the core wire crimp section is sheathed, the portion of an upper peripheral wall is pinched between the terminal back face and the tube fixing claw, and the other portion of the peripheral wall except the one of the peripheral wall surrounds the core wire crimp section located at a lower position, to thus form a sagging. The adhesive converges at the core wire crimp section located at the lower position, whereby the core crimp section in the heat shrinkable tube is thoroughly filled with the adhesive.

(7) A terminal-equipped electric wire includes a terminal having a core wire crimp section; an electric wire whose core wires are crimped to the core wire crimp section; a heat shrinkable tube that covers the core wire crimp section; and an adhesive that is provided in the heat shrinkable tube and solidified so as to close an opening of a terminal-side one tube end with a closed surface orthogonal to an axis of the heat shrinkable tube.

In the terminal-equipped electric wire having the configuration described in connection with (7), the terminal-side opening of the heat shrinkable tube that covers the core wire crimp section is closed with the closed surface orthogonal to the axis of the heat shrinkable tube made of the solidified adhesive. Accordingly, the one tube end can be closed up to its open end with a sufficient volume of adhesive. Thus, the one tube end filled with the adhesive can be placed in close proximity to the electrical contact. A length of the terminal from the electrical contact to the other tube end can be shortened by an amount corresponding to the distance over which the one tube end is made close to the electrical contact.

The heat shrinkable tube mount method and the heat shrinkable tube mounting jig of the invention make it possible to reliably fix the heat shrinkable tube without involvement of an adhesive leakage, so that the heat shrinkable tube positioned in close proximity to the electrical contact can be filled up to its open end with the adhesive.

Further, the length of the terminal-equipped electric wire of the invention can be shortened by an amount corresponding to the distance from the terminal to the tube other end.

The invention has been briefly described thus far. Details of the invention will be more clarified by reading through a mode for implementing the invention (hereinafter called an “embodiment”) to be described below, by reference to the accompanying drawings.

### BRIEF DESCRIPTION OF THE DRAWINGS

FIG. 1 is a plan view of a heat shrinkable tube mounting jig of an embodiment of the invention;

FIG. 2 is an enlarged perspective view of a tube fixing claw shown in

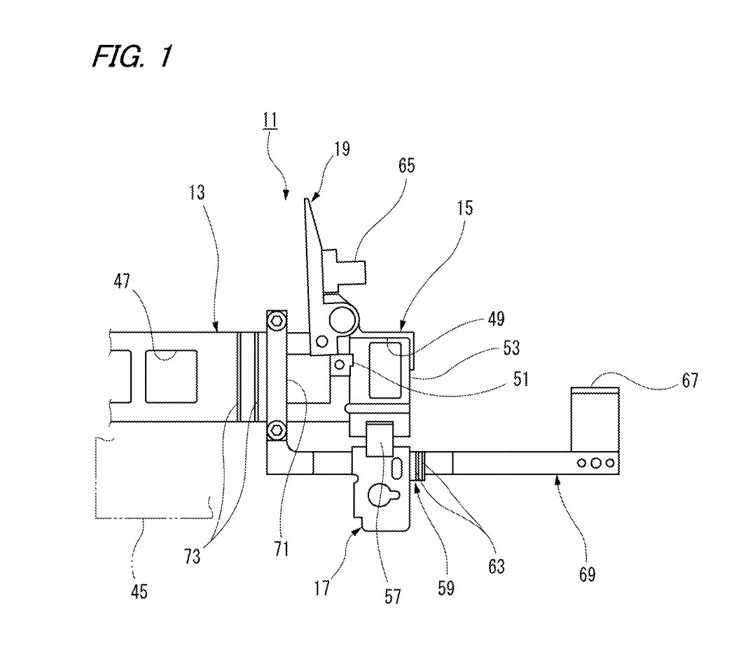

FIG. 1;

FIG. 3 is a plan view of a terminal-equipped electric wire of the embodiment of the invention;

FIG. 4 is a diagram for explaining a process of attaching a terminal to a terminal fit recess;

FIG. 5 is an enlarged view of a principal part of FIG. 4;

FIG. 6A is a diagram for explaining a process of bringing into contact with a dam wall one end of a heat shrinkable tube in which a core wire crimp section is sheathed, and FIG. 6B is a diagram for explaining operation of a clamp lever;

FIG. 7 is an enlarged perspective view of a principal part showing that a circumferential wall is partially pinched by the tube fixing claw;

FIG. 8A is a plan view of the terminal-equipped electric wire in which a plate for ensuring clearance for filling purpose is inserted between a plurality of electric wires, and FIG. 8B is an enlarged view of the heat shrinkable tube fixed in proximity to an electric wire contact of the terminal;

FIG. 9A is a perspective view showing a surface of a terminal on a part of the core wire crimp section of the terminal-equipped electric wire waterproofed by the heat shrinkable tube, and FIG. 9B is a perspective view showing a back of the terminal of the terminal-equipped electric wire shown in FIG. 9A; and

FIG. 10 is a side view of a jig used for manufacturing an existing waterproof lead outfitted with a terminal-equipped electric wire.

### DETAILED DESCRIPTION OF THE EXEMPLARY EMBODIMENTS

An embodiment of the invention is hereunder described by reference to the drawings.

As shown in FIG. 1, a heat shrinkable tube mounting jig 11 of the embodiment is generally divided into a base 13, a lower frame 15, an upper frame 17, and a clamp lever 19. The heat shrinkable tube mounting jig 11 is used when a terminal-equipped electric wire 21 is waterproofed (see FIG. 3). Waterproofing is performed by use of a heat shrinkable tube 27 that shrouds a core wire crimp section 25 of a terminal 23 connected to an end of an electric wire 41. Hot melt 29 that is to serve as an adhesive is provided inside the heat shrinkable tube 27. The terminal-equipped electric wire 21 outfitted to the heat shrinkable tube mounting jig 11 is input into an unillustrated heater along with the heat shrinkable tube mounting jig 11. The heat shrinkable tube 27 thereupon contracts, and the core wire crimp section 25 is filled with the molten hot melt 29 positioned inside the heat shrinkable tube 27, thereby waterproofing the terminal-equipped electric wire 21.

In the embodiment, the terminal 23 is described by taking, as an example, an LA terminal to be connected to a battery placed in an engine room of an automobile, and the like. However, the terminal can be any terminal to be used in another application, so long as the terminal has the core wire crimp section 25 requiring waterproof treatment.

As shown in FIG. 3, the terminal 23 is made up of a terminal board 31; an electrical contact 35 that is formed on a front end side of the terminal board 31 and that has an insert hole 33; the core wire crimp section 25 formed on a back end side of the terminal board 31; and a shield crimp section 37 formed on a back end side of, while being spaced apart from, the core wire crimp section 25. Core wires 43 of the electric wire 41 from which an insulating shield 39 is removed are crimped to the core wire crimp section 25. The electric wire 41 is crimped to the shield crimp section 37 from the periphery of the insulating shield 39. In the embodiment, the two electric wires 41 are connected to the terminal 23.

The heat shrinkable tube mounting jig 11 is input into an unillustrated heater outfitted with a heating section, along with the outfitted terminal-equipped electric wire 21. The heater is provided with a conveyor belt for conveying the heat shrinkable tube mounting jig 11 to the heating section. Accordingly, the terminal-equipped electric wire 21 outfitted to the heat shrinkable tube mounting jig 11 is conveyed to an interior of the heater by means of the conveyor belt.

As shown in FIG. 1, the heat shrinkable tube mounting jig 11 of the embodiment has the long frame-shaped base 13 to be mounted on a mount surface 45 of a terminal set table. Retainer holes 47 used when the terminal-equipped electric wire 21 is cooled in conjunction with the heat shrinkable tube mounting jig 11 after heat treatment are formed in the base 13.

The lower frame 15 is provided at a front end of the base 13, and a terminal fit recess 49 is formed in an upper surface of the lower frame 15. The terminal fit recess 49 is a rectangular shape that is substantially identical with an outer shape of the terminal 23 of the terminal-equipped electric wire 21, and can restrict in-plane movement of the terminal 23.

A portion of a front-end-side peripheral wall of the terminal fit recess 49 is cut to prevent from interfering with the terminal board 31 of the terminal 23 positioned so as to be capable of fitting. The terminal 23 of the embodiment has a shape such that the terminal board 31 becomes asymmetrical with respect to an axis 81 of the heat shrinkable tube 27 (see FIG. 9A). Accordingly, when being positioned so as to fit to the terminal fit recess 49, the terminal 23 can be set in such a way that a terminal back face 75 is oriented upward and that the core wire crimp section 25 is oriented downward. However, when an attempt is made to set the core wire crimp section 25 so as to be oriented upwards, the terminal board 31 interferes with the peripheral wall of the terminal fit recess 49. Accordingly, erroneous setting of the terminal 23, which would otherwise occur when the terminal 23 is arranged so as to fit the terminal fit recess 49, is prevented.

A temporary retention claw 51 is provided on the terminal fit recess 49 on an upper surface of the base 13. As shown in FIGS. 4 and 5, the temporary retention claw 51 locks a front-end-side outer edge of the terminal 23, which is positioned so as to fit the terminal fit recess 49, on the terminal board 31, thereby restricting uplift of the terminal 23 from the terminal fit recess 49. The thus-positioned temporary retention claw 51 enables the terminal fit recess 49 to temporarily retain the terminal 23 before the upper frame 17 having turned covers the terminal fit recess 49. Thus, sheathing work by means of which the core wire crimp section 25 must be sheathed in the heat shrinkable tube 27 before turning of the upper frame 17 is facilitated.

A dam wall 53 is formed on a front-end edge of the lower frame 15. A one tube end 55 (see FIG. 4) of the heat shrinkable tube 27 in which the electric wire 41 of the terminal-equipped electric wire 21 is sheathed comes into contact with the dam wall 53. The upper frame 17 is joined to one-side edge of the lower frame 15 in a turnable manner by way of a hinge 57. The upper frame 17 covers the terminal fit recess 49, thereby restricting movement of the terminal 23 in a direction orthogonal to the terminal back face 75 that is one plane of the terminal 23.

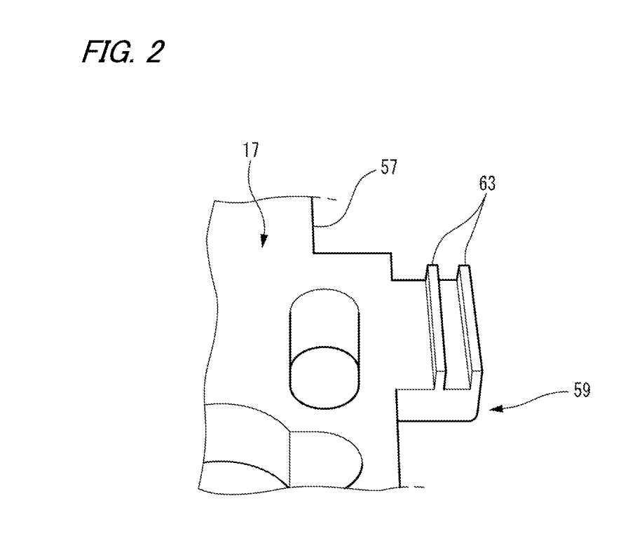

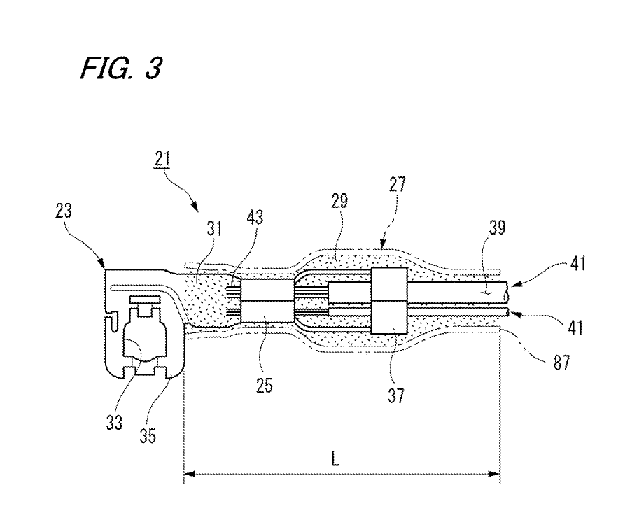

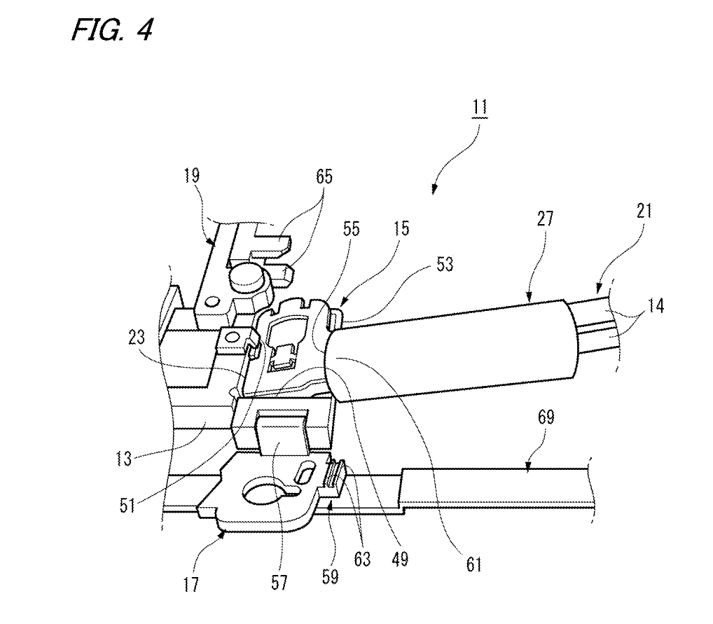

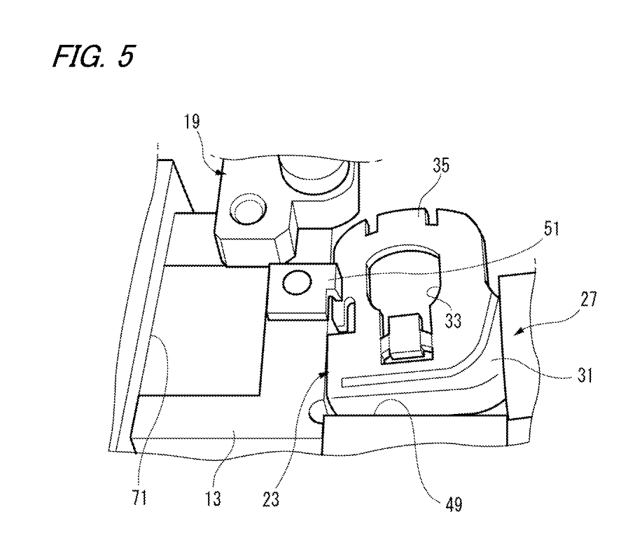

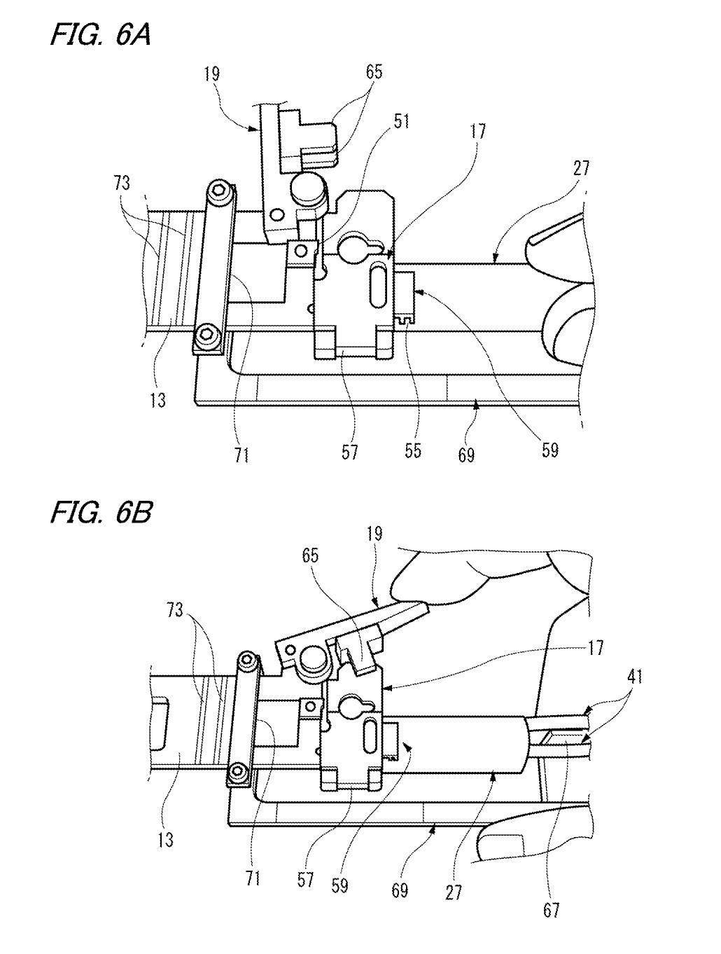

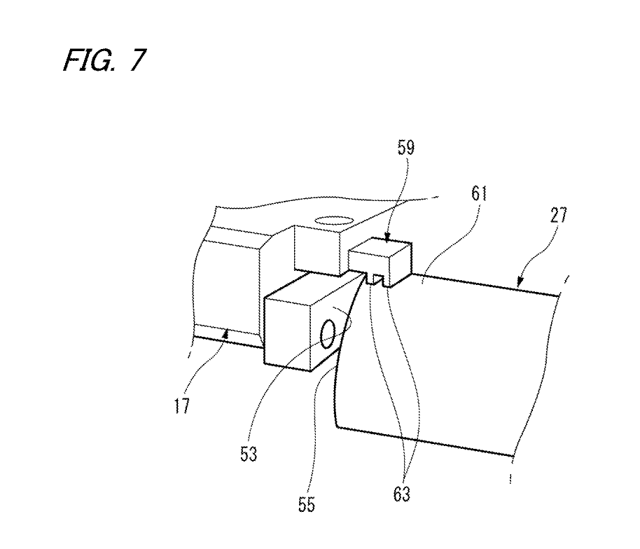

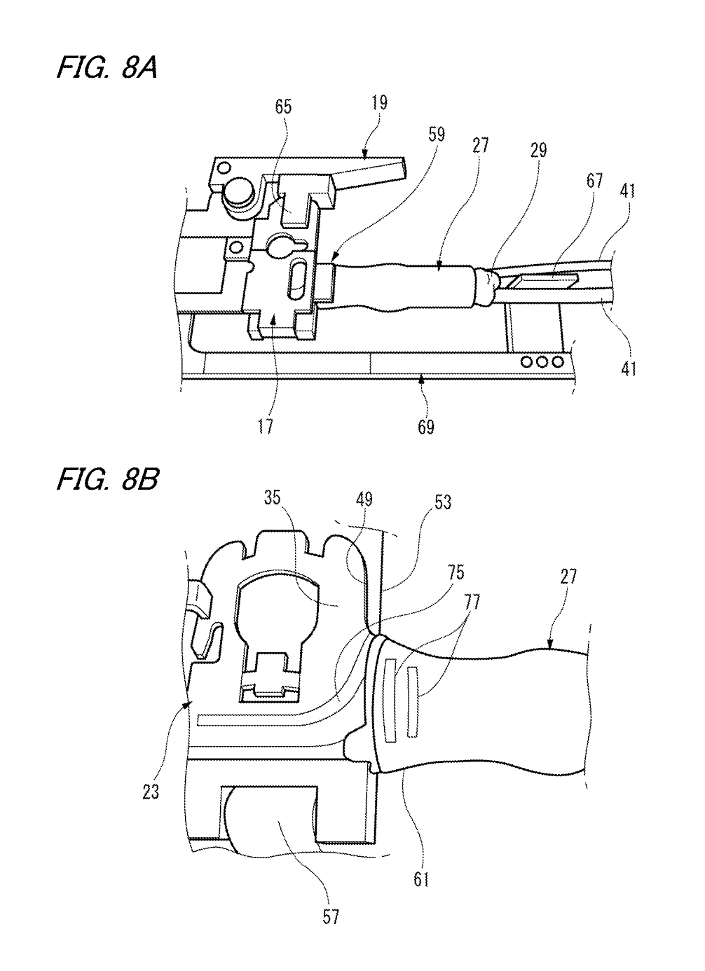

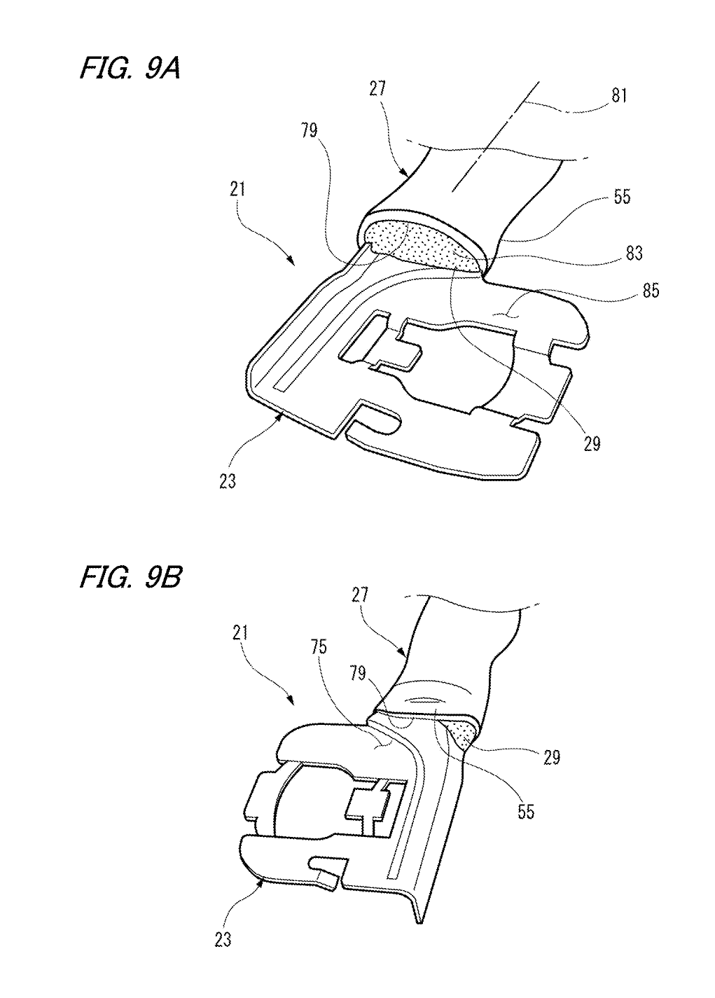

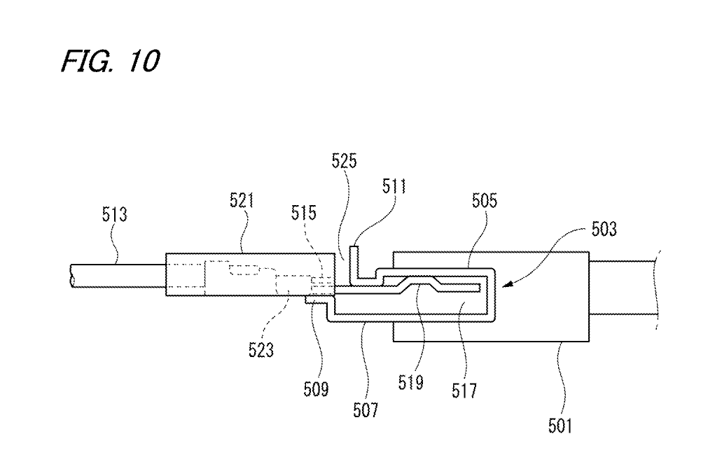

The front-end edge of the upper frame 17 is provided with a tube fixing claw 59 that projects in a direction parallel to the electric wire 41. The tube fixing claw 59 pinches a portion 61 (see FIG. 4) of the peripheral wall of the heat shrinkable tube 27 along with the terminal 23 fixedly nipped between the lower frame 15 and the upper frame 17. As shown in FIG. 2, the tube fixing claw 59 has a plurality of parallel linear press teeth 63 that extend in a direction orthogonal to an axial direction of the heat shrinkable tube 27. Since the tube fixing claw 59 that presses the portion 61 of the peripheral wall of the heat shrinkable tube 27 has the linear press teeth 63, the tube fixing claw 59 can pinch the portion 61 of the peripheral wall by dint of contact force that is greater than that generated by a planar pressing tooth, thereby rendering disengagement of the heat shrinkable tube 27 more difficult.

The clamp lever 19 that is turned to a pinching position where the clamp lever 19 pinches the lower frame 15 and the upper frame 17 is provided on a side of the base 13 in a turnable manner. A pair of parallel pinching pieces 65 (see FIG. 4) are formed on the clamp lever 19, and the pair of pinching pieces 65 fixedly pinch a swayable end side of the upper frame 17 superposed on the lower frame 15.

A plate 67 that is to be used for ensuring clearance for filling purpose and be inserted among the plurality of electric wires 41 (two in the embodiment) led out of the heat shrinkable tube 27 is removably provided on the base 13 of the embodiment. The plate 67 is provided on a front-end side of a support lever 69. A base-end side of the support lever 69 is provided with a fixing section 71, and the fixing section 71 is fixedly fastened while the base 13 is sandwiched between the fixing section 71 and the support lever 69. A plurality of positioning grooves 73 for positioning the fixing section 71 are formed in the base 13. As a matter of course, when the electric wire 41 to be connected to the terminal 23 is one, the plate 67 is removed.

When the electric wire 41 is provided in number of two as described in connection with the embodiment, the plate 67 is sandwiched between the electric wires 41 as shown in FIG. 8A. Accordingly, the plate 67 prevents the two electric wires 41 from twisting, thus enabling parallel layout of the two electric wires 41. A space between the electric wires 41 can thereby be filled with the hot melt 29 without fail, thereby preventing a space not filled with the hot melt 29 from developing between the electric wires 41.

In the heat shrinkable tube mounting jig 11 of the embodiment, the terminal board 31 of the terminal 23 is arranged so as to fit to the terminal fit recess 49 in a direction in which the core wire crimp section 25 faces down (see FIG. 4). Of the terminal 23 placed in the terminal fit recess 49, the terminal back face 75 faces up, whilst the core wire crimp section 25 faces down.

As shown in FIG. 7, of the heat shrinkable tube 27 in which the core wire crimp section 25 is sheathed, the portion 61 of the upper peripheral wall is pinched between the terminal back face 75 (see FIG. 8B) of the terminal board 31 and the tube fixing claw 59. A remaining portion of the peripheral wall except the portion 61 surrounds the lower core wire crimp section 25, to thus form a sagging. Therefore, the molten hot melt 29 is gathered toward the core wire crimp section 25 situated at a lower position. Thus, the core wire crimp section 25 in the heat shrinkable tube 27 is thoroughly filled with the hot melt 29.

Operation of the heat shrinkable tube mounting jig 11 having the above configuration is now described.

In the heat shrinkable tube mounting jig 11, the terminal board 31 is fitted into the terminal fit recess 49 of the lower frame 15 while the terminal back face 75 is oriented up in such a way that the front-end side edge of the terminal board 31 gets into under the temporary retention claw 51. The electric wires 41 and the core wire crimp section 25, which are led out of the terminal 23 fitted to the terminal fit recess 49, are sheathed with the heat shrinkable tube 27. In the heat shrinkable tube 27, the one tube end 55 is brought into contact with the dam wall 53 of the lower frame 15 (see FIG. 4).

In this state, the upper frame 17 is turned, whereupon the terminal 23 becomes fixedly pinched between the lower frame 15 and the upper frame 17. Concurrently, the tube fixing claw 59 projectingly provided on the upper frame 17 is pressed against the portion 61 of the peripheral wall of the one tube end 55. Since the portion 61 of one tube end 55 is pinched between the terminal board 31, which is held between the lower frame 15 and the upper frame 17, and the tube fixing claw 59. Hence, the one tube end 55 can be reliably pinched. An opening 79 (see FIG. 9A) of the one tube end 55 is closed by the dam wall 53, and the portion 61 is fastened to the base 13 by means of the terminal 23 and the tube fixing claw 59. This eliminates clearance between the dam wall 53 and the one tube end 55 from which the hot melt 29 might run out. Thus, the one tube end 55 can be placed in close proximity to the electrical contact 35 of the terminal 23.

The heat shrinkable tube mount method of the embodiment is now described.

In order to mount the heat shrinkable tube 27 to the terminal-equipped electric wire 21 by use of the above-described heat shrinkable tube mounting jig 11, the terminal 23 of the terminal-equipped electric wire 21 is first fitted to the terminal fit recess 49 of the lower frame 15 provided on the base 13 as shown in FIG. 4.

On this occasion, as shown in FIG. 5, the temporary retention claw 51 is engaged with the front-end-side edge of the terminal board 31, thereby preventing the terminal 23 fitted to the terminal fit recess 49 from being uplifted from the terminal fit recess 49. The terminal 23 can be temporarily held in the terminal fit recess 49 before the turned upper frame 17 covers the terminal fit recess 49. Thus, the sheathing work by means of which the core wire crimp section 25 must be sheathed in the heat shrinkable tube 27 before turning of the upper frame 17 is facilitated.

Next, as shown in FIG. 6A, the core wire crimp section 25 led out of the lower frame 15 is sheathed with the heat shrinkable tube 27 containing therein the hot melt 29, and the one tube end 55 is brought into contact with the dam wall 53 of the lower frame 15 (see FIG. 4). A space to be filled with the hot melt 29 is formed at the one tube end 55 as a result of the opening 79 being closed by the dam wall 53.

Subsequently, the upper frame 17 joined in a turnable manner to the lower frame 15 by way of the hinge 57 covers the terminal fit recess 49, thereby restricting movement of the terminal 23 in a direction orthogonal to the mount surface 45 of the terminal set table (see FIG. 1). As shown in FIG. 7, the instant when the terminal fit recess 49 is closed, the portion 61 of the peripheral wall of the heat shrinkable tube 27 is pinched between the tube fixing claw 59 projectingly provided on the upper frame 17 and the terminal board 31 of the terminal 23.

Next, as shown in FIG. 6B, the clamp lever 19 disposed on the base 13 so as to be turnable is turned to the pinching position, thereby pinching the lower frame 15 and the upper frame 17. Further, the plate 67 is inserted between the two electric wires 41.

The heat shrinkable tube mounting jig 11 holding the terminal 23 is thus input into the unillustrated heater along with the terminal-equipped electric wire 21. As shown in FIG. 8A, the heat shrinkable tube 27 heated by the heater contracts in its radially inward direction and filled with the molten hot melt 29, thereby being waterproofed. In the heat shrinkable tube 27 fixed by the linear press teeth 63, the one tube end 55 is fixed in proximity to the electrical contact 35 while a crimp impression 77 is left on the portion 61 of the peripheral wall facing the terminal back face 75.

The terminal-equipped electric wire 21 thus outfitted with the heat shrinkable tube 27 is made up of the terminal 23 having the core wire crimp section 25 (see FIG. 3); the electric wires 41 in which the core wires 43 (see FIG. 3) are crimped to the core wire crimp section 25; the heat shrinkable tube 27 into which the electric wires 41 are sheathed and that covers the core wire crimp section 25; and the hot melt 29 that has been solidified so as to fill up the heat shrinkable tube 27, thereby closing the opening 79 of the one tube end 55 (see FIG. 9A) by means of a closed surface 83 that is orthogonal to an axial line 81 of the heat shrinkable tube 27.

As shown in FIG. 9A, in the thus-configured terminal-equipped electric wire 21, the terminal-side opening 79 of the heat shrinkable tube 27 covering the core wire crimp section 25 is closed by means of the closed surface 83 that is orthogonal to the axial line 81 of the heat shrinkable tube 27 made up of the solidified hot melt 29. Accordingly, it is possible to close the one tube end 55 up to its open end with a sufficient volume of hot melt 29. Thus, the one tube end 55 filled with the hot melt 29 can be placed in close proximity to the electrical contact 35. As shown in FIG. 9B, a length L (see FIG. 3) from the electrical contact 35 of the terminal 23 to a remaining tube end 87 can be shortened by an amount corresponding to a distance over which the one tube end 55 was made close to the electrical contact 35.

As a consequence, according to the heat shrinkable tube mount method and the heat shrinkable tube mounting jig 11 of the embodiment, the heat shrinkable tube 27 can be reliably fixed without involvement of leakage of the hot melt 29. It is possible to fill the heat shrinkable tube 27, which is positioned in close proximity to the electrical contact 35, up to its open end with the hot melt 29.

Moreover, the length of the terminal-equipped electrical contact 21 of the embodiment from the electrical contact 35 of the terminal 23 to the remaining tube end 87 can be shortened.

The heat shrinkable tube mount method, the heat shrinkable tube mounting jig, and the terminal-equipped electric wire of the invention are not limited to those described in connection with the embodiment and are susceptible to alterations, modifications, and the like. In addition, materials, geometries, dimensions, locations, and the number of constituent elements described in connection with the embodiment are not restricted and arbitrary, so long as the invention can be accomplished.

The present invention is useful for providing a heat shrinkable tube mount method, a heat shrinkable tube mounting jig, and a terminal-equipped electric wire that make it possible to reliably fix a heat shrinkable tube without involvement of an adhesive leakage and fill the heat shrinkable tube, which is located in close proximity to an electrical contact, up to its open end with an adhesive.

What is claimed is:

1. A heat shrinkable tube mount method comprising:
fitting a terminal of a terminal-equipped electric wire to a terminal fit recess of a lower frame provided on a base;
sheathing a core wire crimp section of the terminal led out of the lower frame with a heat shrinkable tube containing therein an adhesive and bringing a one tube end into contact with a dam wall of the lower frame;
restricting movement of the terminal in a direction orthogonal to one plane of the terminal, by covering the terminal fit recess with an upper frame that is joined to the lower frame in a turnable manner;
pinching a portion of a peripheral wall of the heat shrinkable tube between a tube fixing claw projectingly provided on the upper frame and the terminal at an instant when the upper frame covers the terminal fit recess; and
turning a clamp lever, which is provided on the base in a turnable manner, to a pinching position, where the clamp lever pinches the lower frame and the upper frame.

2. A heat shrinkable tube mounting jig comprising:
a lower frame that is provided on a base and that has a terminal fit recess for restricting in-plane movement of a terminal of a terminal-equipped electric wire;
a dam wall that is formed on the lower frame and with which a one tube end of a heat shrinkable tube, in which a core wire crimp section of the terminal is sheathed, is brought into contact;
an upper frame that is joined to the lower frame in a turnable manner and covers the terminal fit recess, to thus restrict movement of the terminal in a direction perpendicular to the one plane of the terminal;
a tube fixing claw that is provided projectingly on the upper frame and that pinches a portion of a peripheral wall of the heat shrinkable tube along with the terminal; and
a clamp lever that is provided on the base in a turnable manner and that is turned to a pinching position, to thus pinch the lower frame and the upper frame.

3. The heat shrinkable tube mounting jig according to claim 2, wherein the tube fixing claw as a plurality of parallel press teeth that extend in a direction orthogonal to an axial direction of the heat shrinkable tube.

4. The heat shrinkable tube mounting jig according to claim 2, wherein the base has a temporary retention claw that is engaged with an edge of the terminal positioned in the terminal fit recess, thereby restricting uplift of the terminal from the terminal fitting recess.

5. The heat shrinkable tube mounting jig according to claim 2, wherein the base is provided with a plate for ensuring clearance to be filled that is inserted between a plurality of electric wires connected to the terminal.

6. The heat shrinkable tube mounting jig according to claim 2, wherein the terminal fitting recess fits to the terminal in a direction in which the core wire crimp section faces down, and the tube fixing claw pinches the portion of the peripheral wall along with a terminal back face, which is an opposite side, of the core wire crimp section.
